(19) United States
(12) Patent Application Publication
(10) Pub. No.: US 2024/0128029 A1
(43) Pub. Date: Apr. 18, 2024

(54) SOLID ELECTROLYTIC CAPACITOR AND MANUFACTURING METHOD THEREFOR

(71) Applicant: Panasonic Intellectual Property Management Co., Ltd., Osaka (JP)

(72) Inventor: DAISUKE USA, Osaka (JP)

(21) Appl. No.: 18/546,504

(22) PCT Filed: Feb. 22, 2022
(86) PCT No.: PCT/JP2022/007215

§ 371 Date: Aug. 15, 2023

(30) Foreign Application Priority Data
Feb. 26, 2021 (JP) 2021-029880

(51) Int. Cl. H01G 9/15; H01G 9/055

(52) U.S. Cl. CPC H01G 9/15; H01G 9/055; H01G 9/0029

(57) ABSTRACT

A solid electrolytic capacitor includes a capacitor element including an anode foil including a porous part in a surface layer, a dielectric layer, and a solid electrolyte layer. The anode foil includes a first part including a first end and being not provided with the solid electrolyte layer, and a second part including a second end opposite to the first end and excluding the first part, the anode foil having a first principal surface and a second principal surface opposite to the first principal surface. The capacitor element further includes a first insulating region located at side close to the first principal surface and a second insulating region located at side close to the second principal surface between the first end and the second end. Water repellency R2 of at least a part of the second insulating region is higher than water repellency R1 of the first insulating region.

### TECHNICAL FIELD

The present disclosure relates to a solid electrolytic capacitor and a manufacturing method therefor.

### BACKGROUND

A solid electrolytic capacitor includes a solid electrolytic capacitor element, an exterior body that seals the solid electrolytic capacitor element, and an external electrode electrically connected with the solid electrolytic capacitor element. The solid electrolytic capacitor element includes an anode foil, a dielectric layer formed on a surface of the anode foil, and a cathode part covering at least a part of the dielectric layer. The cathode part includes a solid electrolyte layer covering at least a part of the dielectric layer and containing a conductive polymer. The solid electrolyte layer is formed using a treatment solution containing a conductive polymer, for example. The solid electrolyte layer can also be formed by chemical polymerization or electrolytic polymerization using a polymerization liquid containing a precursor of the conductive polymer.

PTL 1 proposes a method for manufacturing a solid electrolytic capacitor, the method including the steps of: anodization in which a surface of a valve metal is roughened to form a dielectric oxide film layer on the surface of the valve metal; forming a first forbidden band and a second forbidden band for preventing permeation of a conductive polymer material to form a boundary part between an anode lead-out part and a cathode part on the valve metal, and forming an insulating member in the first forbidden band and the second forbidden band; sequentially forming a solid electrolyte layer and a conductor layer on a surface of the cathode part; and post-treatment in which a lead terminal is attached to each of the anode lead-out part and the conductor layer, and the anode lead-out part and the conductor layer are covered with an exterior resin to cause a part of the lead terminal to be exposed.

### CITATION LIST

### Patent Literature

PTL 1: Unexamined Japanese Patent Publication No. 2003-7571

### SUMMARY OF THE INVENTION

A solid electrolytic capacitor according to a first aspect of the present disclosure includes a capacitor element including an anode foil including a porous part in a surface layer of the anode foil, a dielectric layer covering at least a part of the porous part, and a solid electrolyte layer covering at least a part of the dielectric layer. The anode foil has a first principal surface and a second principal surface opposite to the first principal surface. And the anode foil includes a first part and a second part, the first part including a first end and being not provided with the solid electrolyte layer, the second part including a second end opposite to the first end and excluding the first part. The capacitor element further includes a first insulating region and a second insulating region between the first end and the second end. The first insulating region is located at side close to the first principal surface, and the second insulating region is located at side close to the second principal surface. Water repellency R2 of at least a part of the second insulating region is higher than water repellency R1 of the first insulating region.

A method for manufacturing a solid electrolytic capacitor according to a second aspect of the present disclosure, the solid electrolytic capacitor including a capacitor element including an anode foil including a porous part on a surface layer, a dielectric layer covering at least a part of the porous part, and a solid electrolyte layer covering at least a part of the dielectric layer, the anode foil including a first part and a second part, the first part including a first end and being not provided with the solid electrolyte layer, the second part including a second end opposite to the first end and excluding the first part, the anode foil having a first principal surface and a second principal surface opposite to the first principal surface, the method comprising a step of forming a first insulating region and a second insulating region between the first end and the second end, the first insulating region being located at a side close to the first principal surface, the second insulating region being located at a side close to the second principal surface. Water repellency R2 of at least a part of the second insulating region is higher than water repellency R1 of the first insulating region.

The present disclosure enables reducing a leakage current in a solid electrolytic capacitor.

### BRIEF DESCRIPTION OF THE DRAWINGS

FIG. 1 is a schematic sectional view illustrating a solid electrolytic capacitor according to an exemplary embodiment of the present disclosure.

FIG. 2 is a sectional view schematically illustrating a solid electrolytic capacitor element included in the solid electrolytic capacitor of FIG. 1.

### DESCRIPTION OF EMBODIMENT

Prior to the description of an exemplary embodiment, problems in the prior art are briefly described below.

Since a part of the anode foil (referred to as an anode part) at a side close to one end is connected to an anode lead terminal, a cathode part including a solid electrolyte layer is formed in an anther part of the anode foil at a side close to the other end. To ensure insulation between the anode part and the cathode part, an insulating part is provided at or near an end part of the anode part, the end part being located at a side close to the cathode part.

When the solid electrolyte layer is formed by electrolytic polymerization, a power feeder (such as a power feeding tape) is connected to the insulating part on one principal surface of the anode foil, for example. While the anode foil is in contact with a precursor of a conductive polymer, polymerization voltage is applied to the power feeder, and polymerization of the precursor of the conductive polymer (more specifically, a precursor of a conjugated polymer contained in the conductive polymer) proceeds from an end part of the power feeder to form the solid electrolyte layer containing the conductive polymer. The power feeder is connected to the insulating part on the one principal surface (first principal surface) of the anode foil while covering most of the insulating part. Thus, polymerization of the precursor of the conductive polymer is hindered on a surface of the insulating part, which is on the first principal surface. However, since the insulating part has an exposed surface on the other principal surface (second principal surface) of the anode foil, polymerization of the precursor easily proceeds in the exposed surface to tend to form the solid electrolyte layer. When the solid electrolyte layer is formed on the surface of the insulating part, a leakage current increases.

In view of the above problem, the present disclosure allows a first insulating region to be formed on the first principal surface of the anode foil, and a second insulating region to be formed on the second principal surface of the anode foil. Then, water repellency R2 of at least a part of the second insulating region is higher than water repellency R1 of the first insulating region. This configuration allows polymerization of the precursor of the conductive polymer to be less likely to proceed on a surface of the second insulating region, thereby suppressing formation of the solid electrolyte layer. Thus, the leakage current can be reduced. Additionally, a solid electrolytic capacitor can be reduced in a short circuit failure rate.

Water repellency R1 and water repellency R2 can be each expressed by a static contact angle of water with respect to a material included in corresponding one of the insulating regions. When the insulating region has high water repellency, or a large static contact angle of water with respect to the material contained in the insulating region, the insulating region decreases in affinity or wettability for a polymerization liquid containing the precursor of the conductive polymer used for the electrolytic polymerization. Thus, water repellency R1 and water repellency R2 can be referred to as indicators of repelling the polymerization liquid in the corresponding insulating regions.

The anode foil in the present disclosure has a first end and a second end opposite to the first end. The solid electrolyte layer is formed on a part of the anode foil located at a side close to the second end, and is not formed on a part of the anode foil located at a side close to the first end. A part including the first end and being not provided with the solid electrolyte layer of the anode foil is referred to as a first part. The first part corresponds to an anode part. The first part is connected to an anode lead terminal. The anode foil includes a part other than the first part, the part being referred to as a second part. The second part includes the second end.

The anode foil has the first principal surface and the second principal surface opposite to the first principal surface as a pair of principal surfaces occupying most of a surface of the anode foil. The anode foil has end surfaces at respective ends of the first principal surface and the second principal surface. The first principal surface, the second principal surface, and the end surfaces form an outer shape of the anode foil.

Herein, a direction extending from the first end to the second end of the anode foil is defined as a length direction of the anode foil, and a direction perpendicular to the length direction of the anode foil is defined as a width direction of the anode foil when a principal surface of the anode foil is viewed from a direction perpendicular to the principal surface. The width direction of the anode foil is also perpendicular to a thickness direction of the anode foil. The direction extending from the first end to the second end is a direction parallel to a linear direction of the anode foil, the linear direction connecting a center of the end surface at the first end and a center of the end surface at the second end.

Hereinafter, the solid electrolytic capacitor of the present disclosure and a method for manufacturing the solid electrolytic capacitor will be described more specifically with reference to the drawings as necessary.

### [Solid Electrolytic Capacitor]

The solid electrolytic capacitor includes a solid electrolytic capacitor element including anode foil with a surface layer including a porous part, a dielectric layer covering at least a part of the porous part, and a cathode part covering at least a part of the dielectric layer. The solid electrolytic capacitor element may be simply referred to below as a capacitor element.

### (Anode Foil)

The anode foil can include a valve metal, an alloy containing the valve metal, a compound including the valve metal, and the like. These materials may be used singly or in combination of two or more kinds of these materials. Preferably available examples of the valve metal include aluminum, tantalum, niobium, and titanium.

The anode foil includes a base material part and a porous part in each of surface layers respectively positioned on both main surfaces of the base material part. The porous part may be formed in not only the surface layers of the anode foil, but also a part other than the surface layers as necessary. The anode foil may have the porous part in the surface layer of at least a part of the second part, and thus may have the porous part in the surface layer of the entirety of the second part, or in the surface layer of the entirety of the anode foil. The anode foil including the porous part in the surface layer is formed by roughening a surface of a base material (metal foil or the like) in a sheet shape containing a valve metal, for example. The roughening can be performed by etching treatment (e.g., electrolytic etching), for example.

### (Dielectric Layer)

The dielectric layer is an insulating layer that functions as a dielectric. The dielectric layer is formed by anodizing the valve metal on the surface of the anode foil by anodizing treatment or the like. The dielectric layer may be formed covering at least a part of the porous part of the anode foil. The dielectric layer is typically formed on the surface of the anode foil. Thus, the dielectric layer is formed along unevenness of the surface of the anode foil and an inner wall surface of a void in the porous part.

The dielectric layer is formed on a surface of at least a part of the second part of the anode foil, for example. The dielectric layer may be formed on a surface of at least a part of the first part of the anode foil as necessary.

The dielectric layer contains an oxide of the valve metal. For example, when tantalum is used as the valve metal, the dielectric layer contains Ta₂O₅, and when aluminum is used as the valve metal, the dielectric layer contains Al₂O₃. The dielectric layer is not limited to these examples, and may be made of a material that functions as a dielectric.

### (Insulating Region or Insulating Part)

The capacitor element includes a first insulating region and a second insulating region between the first end and the second end of the anode foil. The first insulating region is located at a side close to the first principal surface of the anode foil and the second insulating region is located at a side close to the second principal surface. The solid electrolyte layer is formed by performing the electrolytic polymerization while the power feeder is connected to the first insulating region and the anode foil including the dielectric layer is in contact with the polymerization liquid containing the precursor of the conductive polymer (e.g., in an immersed state). Water repellency R2 of at least a part of the second insulating region is higher than water repellency R1 of the first insulating region. Thus, progress of polymerization of the precursor of the conductive polymer is hindered in the second insulating region, so that formation of the solid electrolyte layer is suppressed. Insulation between the anode part and the cathode part is accordingly secured, and thus a leakage current can be reduced.

Each of the first insulating region and the second insulating region is preferably provided in a band shape along the width direction of the anode foil. Each insulating region in this case suppresses formation of the solid electrolyte layer along the width direction of the anode foil, and thus enables enhancing effect of securing insulation between the anode part and the cathode part. From the viewpoint of further enhancing the effect, each of the first insulating region and the second insulating region is preferably provided throughout the anode foil in the width direction.

Width w1 of the first insulating region is in a range from 0.01 L to 0.3 L, inclusive, for example, and may be in a range from 0.03 L to 0.15 L, inclusive. Width w1 in such a range facilitates not only connection of the power feeder to more easily ensure insulation between the anode part and the cathode part on the first principal surface, but also ensuring high electrostatic capacity.

Herein, L is a length of the anode foil. Length L of the anode foil is a length of a straight line connecting the center of the end surface at the first end and the center of the end surface at the second end of the anode foil.

Width w2 of the second insulating region is in a range from 0.01 L to 0.3 L, inclusive, for example, and may be in a range from 0.03 L to 0.15, inclusive. Width w2 in such a range facilitates not only more easily ensuring insulation between the anode part and the cathode part on the second principal surface, but also ensuring high electrostatic capacity.

Widths w1 and w2 of the respective insulating regions are lengths of the corresponding insulating regions in a direction along the length direction of the anode foil. Widths w1 and w2 of the respective insulating regions are obtained by measuring widths of the corresponding insulating regions at any places (e.g., ten places) and averaging measured widths. The width of each insulating region and length L of the anode foil can be obtained from a sectional image (e.g., a sectional image captured by a scanning electron microscope) of the solid electrolytic capacitor or the capacitor element.

Measurement of the width of the insulating region and length L of the anode foil allows a sample (sample A) obtained by the following procedure to be used. First, the solid electrolytic capacitor is embedded in a curable resin to cure the curable resin. Polishing treatment or cross-section polishing processing is applied to a cured product to expose a section of the cured product, the section being parallel to the thickness direction of the solid electrolyte layer and perpendicular to the length direction of the capacitor element. The section passes through the center of the end surface at the first end and the center of the end surface at the second end of the anode foil. In this way, the sample for measurement (sample A) is obtained.

Each insulating region may be formed at any position except the first end and the second end as long as the position is between the first end and the second end of the anode foil. The second insulating region may overlap at least a part of the first insulating region in a section parallel to the length direction of the anode foil as viewed in the thickness direction thereof to form the solid electrolyte layer that is substantially equal in length on the first principal surface and the second principal surface of the anode foil.

A position of each insulating region may be determined based on design of the capacitor element. From the viewpoint of easily securing connection to the anode lead terminal and high electrostatic capacity, each insulating region may be provided at a position in a range from 0.1 L to 0.5 L, inclusive, from the first end, or may be provided at a position in a range from 0.1 L to 0.3 L, inclusive, from the first end, for example.

The first insulating region and the second insulating region are required to be formed on at least the first principal surface and the second principal surface of the anode foil, respectively. The anode foil may include an insulating part (first insulating part) formed on the first principal surface, and an outer surface of the first insulating part may constitute the first insulating region. The anode foil may include an insulating part (second insulating part) formed on the second principal surface, and an outer surface of the second insulating part may constitute the second insulating region.

The first insulating part contains a first insulating material, for example. The first insulating region has insulation properties due to the first insulating material. The first insulating part may be formed covering (e.g., like a layer) the first principal surface of the anode foil, or may be included in the porous part close to the first principal surface. Alternatively, the first insulating part may be formed by both of them.

The second insulating part contains a liquid-repellent material with insulation properties. The liquid-repellent material has high water repellency, and has a high effect of repelling the polymerization liquid containing the precursor of the conductive polymer. The liquid-repellent material described above causes the second insulating region to exhibit insulating properties and have high water repellency R2. The second insulating part may be formed covering (e.g., like a layer) the second principal surface of the anode foil, or may be included in the porous part on the second principal surface. Alternatively, the second insulating part may be formed by both of them. The second insulating part includes a part containing the liquid-repellent material with insulation properties, and the part may be referred to as a liquid-repellent part.

The second insulating part may contain a second insulating material. At least a part of the second insulating material in the second insulating part is covered with the liquid-repellent material. This structure causes an outer surface of the second insulating part to constitute the second insulating region and exhibit high water repellency R2. The second insulating material may be disposed covering (e.g., like a layer) the second principal surface of the anode foil, or may be contained in the porous part on the second principal surface. Alternatively, the second insulating material may be disposed by both of them. For example, when the second insulating material is disposed in a layer shape covering the second principal surface, the liquid-repellent material is disposed covering at least a part of the layer of the second insulating material. When the second insulating material is contained in the porous part, the liquid-repellent material may be contained in the porous part, or may be disposed covering the second principal surface. Alternatively, the second insulating material may be contained by both of them. The second insulating part includes a part that does not contain the liquid-repellent material and contains the second insulating material, and the part may be referred to as insulating part 2A. For example, at least a part of insulating part 2A in the second insulating part is covered with the liquid-repellent part.

The anode foil includes a part where the first insulating part and the second insulating part are provided, and the porous part may be compressed, or at least a part of the porous part may be removed in the part, as necessary.

Each insulating region (or each insulating part) has an electric resistance value that is not particularly limited. Each insulating part may have an electric resistance value of more than or equal to 1.0×10¹² Ω·m, or more than or equal to 1.0×10¹³ Ω·m, for example.

Examples of each of the first insulating material and the second insulating material include a cured product of a curable material, a thermoplastic resin, and the like. The first insulating material and the second insulating material may be identical in kind or different in kind. The first insulating region is connected to a power feeder such as a power feeding tape, so that the first insulating region preferably has appropriate tackiness (adhesiveness). Using the first insulating material containing a thermoplastic resin enables not only obtaining appropriate tackiness in the first insulating region to stably perform the electrolytic polymerization, but also restricting formation of the solid electrolyte layer in the first insulating region.

The curable material may be either thermosetting or photocurable. The curable material includes a reactive compound and, as needed, at least one kind selected from a group consisting of a curing agent, a curing accelerator, a polymerization initiator, a catalyst, and an additive, for example. The curable material may be either a one-component curing type or a two-component curing type. The reactive compounds are compounds that can be polymerized or crosslinked by action of heat or light, for example.

Examples of the curable material include phenol resin, urea resin, melamine resin, unsaturated polyester, furan resin, epoxy resin, thermosetting polyurethane resin, allyl resin, silicon resin (silicone), curable acrylic resin, and thermosetting polyimide. Each insulating part may contain one kind of these materials, or may contain two or more kinds thereof in combination. From the viewpoint of high permeability into the porous part, the unsaturated polyester is preferable.

The cured product of the curable material has a glass transition point (Tg) that is not particularly limited. The cured product may have a Tg of more than or equal to 100° C., or more than or equal to 110° C., for example. The cured product may have a Tg of less than or equal to 400° C., less than or equal to 350° C., or less than or equal to 200° C., for example. The Tg can be determined by dynamic viscoelasticity measurement (DMA) under conditions of a temperature raising rate of 2° C./min and a frequency of 1 Hz, for example.

As the thermoplastic resin, engineering plastics are preferable from the viewpoint of excellence in acid resistance, heat resistance, and strength. Examples of the engineering plastics include general engineering plastics and super engineering plastics.

Examples of the thermoplastic resin (such as the engineering plastics) include polyesters, polyamides, polycarbonates, polyacetals, polyphenylene ethers, polyphenylene sulfides, polyether ether ketones, polyacrylic ether ketones, polyamides, polyamideimides, polyimides, polyetherimides, polysulfones, polyethersulfones, polyolefins, and fluororesins (such as polyvinylidene fluoride). Each insulating part may contain one kind of thermoplastic resin, or may contain two or more kinds thereof in combination. From the viewpoint of excellence in acid resistance and heat resistance, the polyamideimide is preferable.

Examples of the liquid-repellent material include a resin material containing a water-repellent group. Examples of the water-repellent group include a hydrocarbon group and a fluorinated hydrocarbon group. Examples of the hydrocarbon group contained in the water-repellent group include an aliphatic hydrocarbon group (such as an alkyl group), an alicyclic hydrocarbon group, and an aromatic hydrocarbon group (e.g., an aryl group such as a phenyl group). Examples of such a resin material include, but are not limited to, a fluororesin, a silicone resin, and a hydrocarbon resin. From the viewpoint of obtaining high water repellency, the fluororesin preferably contains perfluoroolefin as a monomer unit. Examples of such a fluorine resin include polyvinylidene fluoride, polytetrafluoroethylene, and a tetrafluoroethylene-hexafluoropropylene copolymer. Examples of the silicone resin include polysiloxane including a water-repellent group such as an alkyl group or an aryl group in a side chain. The second insulating part (or the liquid-repellent part) may contain one kind of liquid-repellent material, or may contain two or more kinds thereof in combination.

The liquid-repellent part may contain only a liquid-repellent material. From the viewpoint of facilitating adjustment of insulation properties of the second insulating part or formation of the second insulating part (or the liquid-repellent part) while securing high water repellency of the second insulating region, the liquid-repellent part may contain a liquid-repellent material and another resin material. Examples of the other resin material include the thermoplastic resin among the materials exemplified for the first insulating material and the second insulating material. The liquid-repellent part may contain one kind of the other resin material, or two or more kinds thereof. From the viewpoint of excellence in not only acid resistance and heat resistance, but also affinity with a liquid-repellent material, polyamide-imide is preferable as the other resin material.

A content of the liquid-repellent material in the liquid-repellent part may be more than or equal to 0.1 mass %, or more than or equal to 1 mass %, or more than or equal to 10 mass %, for example. A content of the liquid-repellent material in the liquid-repellent part is less than or equal to 100 mass %.

The type of the other resin material contained in the liquid-repellent part and the content of the liquid-repellent material may be determined such that the material contained in the second insulating region has a static contact angle representing water repellency R2 within a range described later, for example.

Water repellency R2 of at least a part of the second insulating region is represented by a static contact angle of water on a material (e.g., a liquid-repellent material) contained in the second insulating region. Water repellency R2 represented by the static contact angle of water on the material such as the liquid-repellent material contained in the second insulating region is more than or equal to 60°, for example, and may be more than or equal to 75°, or more than or equal to 80°. The water repellency R2 is less than or equal to 180°, for example, and may be less than or equal to 150°, or less than or equal to 130°. Water repellency R2 within the range described above further enhances effect of suppressing formation of the solid electrolyte layer in the second insulating region. The range has lower and upper limit values each of which can be appropriately determined. The second insulating region may include at least a part made of a liquid-repellent material exhibiting water repellency R2 described above. When the entirety of the second insulating region is made of the liquid-repellent material exhibiting water repellency R2, insulation between the anode part and the cathode part is more easily secured. When the second insulating region contains a mixture of the liquid-repellent material and another resin material, a static contact angle of water on the mixture corresponds to water repellency R2 and is preferably within the range described above.

Water repellency R1 of the first insulating region is represented by a static contact angle of water on a material (e.g., the first insulating material) contained in the first insulating region. Water repellency R1 represented by a static contact angle of water on the material contained in the first insulating region, such as the first insulating material, is only required to be smaller than water repellency R2 represented by a static contact angle of water on the material contained in the second insulating region, such as the liquid-repellent material or a mixture thereof. The ratio of the water repellency R1 to the water repellency R2 (=R1/R2) is less than 1, and may be less than or equal to 0.95, or less than or equal to 0.9. When the power feeding tape as the power feeder is attached to the first insulating region, water repellency R1 may be less than or equal to 80°, less than 80° or less than or equal to 75°, or less than 75° from the viewpoint of easily securing connection between the power feeder and the first insulating region.

Each of water repellency R1 and water repellency R2 can be measured by a droplet method using a film made of the material contained in the first insulating region, such as the first insulating material, or made of a material contained in the second insulating region, such as the liquid-repellent material or a mixture thereof. More specifically, a static contact angle of a water droplet on the film is measured by a contact angle meter by dropping about 3 μL of distilled water onto the film under an environment of 23° C. and 50 RH %. The static contact angle of a water droplet is measured five times, and an average value is calculated. This average value is used as a static contact angle of water on the material contained in the first insulating region, such as the first insulating material, or on the material contained in the second insulating region, such as the liquid-repellent material or a mixture thereof, and is used as an index of each of water repellency R1 and water repellency R2. As the contact angle meter, “DCA-UZ” manufactured by Kyowa Interface Science Co., Ltd. is used, for example.

(Formation of Insulating Region or Insulating Part) When the solid electrolytic capacitor of the present disclosure is manufactured, the first insulating region is formed on the first principal surface and the second insulating region is formed on the second principal surface between the first end and the second end of the anode foil. Each insulating region is required to be formed such that water repellency R2 of at least a part of the second insulating region is higher than water repellency R1 of the first insulating region.

The first insulating region and the second insulating region may be formed in parallel in the step of forming the insulating region, or any one of the insulating regions may be formed, and then the other of the insulating regions may be formed. The step of forming the insulating region is performed before the step of forming the solid electrolyte layer. Although the step of forming the insulating region may be performed before the step of forming the dielectric layer on the anode foil, it is usually performed after the step of forming the dielectric layer.

The first insulating region is formed, for example, by applying the first insulating material (or the precursor thereof) to a predetermined region on the first principal surface of the anode foil to form the first insulating part containing the first insulating material. The predetermined region is located between the first end and the second end of the anode foil. An outer surface of the formed first insulating part constitutes the first insulating region. The first insulating material (or the precursor thereof) may be applied to the porous part on the first principal surface. The porous part may be impregnated with at least a part of the first insulating material (or the precursor thereof) by application of the first insulating material. The application may cause a film of the first insulating material to be formed on the first principal surface. Alternatively, the first insulating material in a layered shape or a sheet shape may be layered (or transferred) on the first principal surface. From the viewpoint of suppressing formation of the solid electrolyte layer in the porous part, the porous part is preferably impregnated with the first insulating material (or the precursor thereof). The first insulating material (or the precursor thereof) applied to the first principal surface side of the anode foil may be subjected to at least one treatment selected from a group consisting of drying, heating, and light irradiation as necessary. The precursor of the first insulating material is cured by heating, light irradiation, or the like to form the first insulating material. The application of the first insulating material (or the precursor thereof) to the anode foil may be performed in one step or in multiple steps.

The second insulating region is formed, for example, by applying at least a liquid-repellent material to a predetermined region on the second principal surface of the anode foil to form the second insulating part containing the liquid-repellent material. The predetermined region is located between the first end and the second end of the anode foil. An outer surface of the formed second insulating region constitutes the second insulating region. The liquid-repellent material applied to the anode foil may be subjected to drying treatment or heat treatment as necessary. The second insulating part may be formed by applying a mixture containing the liquid-repellent material and another resin material to the second principal surface of the anode foil.

Prior to applying the liquid-repellent material to the anode foil, the second insulating material (or the precursor thereof) may be applied to the second principal surface of the anode foil. In this case, the second insulating part including insulating part 2A containing the second insulating material and the liquid-repellent part containing the liquid-repellent material are formed. The second insulating part described above includes at least a part of the second insulating material which is covered with the liquid-repellent material.

The liquid-repellent material (and the mixture thereof) and the second insulating material (or the precursor thereof) can be each applied to the anode foil in the same manner as in the case of the first insulating material (or the precursor thereof). The second insulating material (or the precursor thereof) applied to the second principal surface of the anode foil may be subjected to at least one treatment selected from the group consisting of drying, heating, and light irradiation as necessary. The precursor of the second insulating material is cured by heating, light irradiation, or the like to form the second insulating material.

Each of the first insulating material, the liquid-repellent material (and other resin material), and the second insulating material may be applied to the anode foil in the form of a liquid mixture (such as a dispersion liquid or a solution) dispersed or dissolved in a liquid medium. Examples of the liquid medium include a medium that is liquid at room temperature (e.g., in a range from 20° C. to 35° C.). Examples of the liquid medium also include at least one kind selected from a group consisting of water and organic solvents.

### (Cathode Part)

The cathode part includes at least the solid electrolyte layer covering at least a part of the dielectric layer. The solid electrolyte layer is formed on a surface of the second part of the anode foil with the dielectric layer interposed therebetween. The cathode part typically includes the solid electrolyte layer, and a cathode lead-out layer covering at least a part of the solid electrolyte layer. Hereinafter, the solid electrolyte layer and the cathode lead-out layer will be described.

### (Solid Electrolyte Layer)

The solid electrolyte layer contains a conductive polymer. The conductive polymer includes a conjugated polymer and a dopant, for example. The solid electrolyte layer may further contain an additive agent as necessary.

Examples of the conjugated polymer include known conjugated polymers used in solid electrolytic capacitors, such as n-conjugated polymers. Examples of the conjugated polymer include polymers including polypyrrole, polythiophene, polyaniline, polyfuran, polyacetylene, polyphenylene, polyphenylene vinylene, polyacene, and polythiophene vinylene as a basic skeleton. Among these polymers, a polymer that adopts polypyrrole, polythiophene, or polyaniline as a basic skeleton is preferable. The polymer is required to contain at least one kind of monomer unit constituting the basic skeleton. The monomer unit also includes a monomer unit including a substituent. The polymer also includes a homopolymer, and a copolymer of two or more kinds of monomer. For example, polythiophene includes poly (3,4-ethylenedioxythiophene) and the like.

Among the conjugated polymers, a conjugated polymer containing a monomer unit corresponding to at least one kind selected from the group consisting of a pyrrole compound, a thiophene compound, and an aniline compound is preferable. Examples of the pyrrole compound include a compound including a pyrrole ring and capable of forming a repeated structure of a corresponding monomer unit. Examples of the thiophene compound include a compound including a thiophene ring and capable of forming a repeated structure of a corresponding monomer unit. These compounds can be linked at the 2-position and 5-position of the pyrrole ring or the thiophene ring to form the repeated structure of the monomer unit. Examples of the aniline compound include a compound including a benzene ring and at least one (preferably one) amino group bonded to the benzene ring and capable of forming a repeated structure of a corresponding monomer unit. The aniline compound can be linked to, for example, an amino group at a CH group (a CH group constituting a benzene ring) moiety at the p-position with respect to the amino group to form the repeated structure of the monomer unit.

The pyrrole compound may have, for example, a substituent at at least one of the 3- and 4-positions of the pyrrole ring. The thiophene compound may have a substituent at at least one of the 3- and 4-positions of the thiophene ring, for example. The substituent at the 3-position and the substituent at the 4-position may be linked to form a ring fused to a pyrrole ring or a thiophene ring. Examples of the pyrrole compound include pyrrole that may have a substituent at at least one of the 3- and 4-positions. Examples of the thiophene compound include thiophene which may have a substituent at at least one of the 3- and 4-positions and an alkylene dioxythiophene compound (C₂₋₄ alkylenedioxythiophene compounds such as ethylenedioxythiophene compounds, and the like). The alkylene dioxythiophene compound also includes those including a substituent in a part of an alkylene group. Examples of the aniline compound include an aniline optionally including a substituent at at least one of the o- and p-positions with respect to an amino group.

The substituent is preferably, but is not limited to, an alkyl group (C₁₋₄ alkyl groups such as methyl group and ethyl group, and the like), an alkoxy group (C₁₋₄ alkoxy groups such as methoxy group and ethoxy group, and the like), a hydroxy group, a hydroxyalkyl group (a hydroxy C₁₋₄ alkyl group such as a hydroxymethyl group, and the like), or the like. When each of the pyrrole compound, thiophene compound, and aniline compound has two or more substituents, the respective substituents may be identical to or different from each other.

A conjugated polymer containing at least a monomer unit corresponding to pyrrole, or a conjugated polymer (such as PEDOT) containing at least a monomer unit corresponding to a 3,4-ethylenedioxythiophene compound (such as 3,4-ethylenedioxythiophene (EDOT)) may be used. The conjugated polymer including at least a monomer unit corresponding to pyrrole may include only a monomer unit corresponding to pyrrole, or may include a monomer unit corresponding to a pyrrole compound other than pyrrole (pyrrole including a substituent, etc.) in addition to the monomer unit. The conjugated polymer including at least a monomer unit corresponding to EDOT may include only a monomer unit corresponding to EDOT, or may include a monomer unit corresponding to a thiophene compound other than EDOT in addition to the monomer unit.

The solid electrolyte layer may contain one kind of conjugated polymer, or may contain two or more kinds thereof in combination.

The conjugated polymer has a weight-average molecular weight (Mw) that is not particularly limited, and that is in a range from 1,000 to 1,000,000, inclusive, for example.

The weight-average molecular weight (Mw) herein is a value in terms of polystyrene measured by gel permeation chromatography (GPC). The GPC is typically measured using a polystyrene gel column, and water and methanol (volume ratio: 8/2) as a mobile phase.

Examples of the dopant include at least one kind selected from a group consisting of an anion and a polyanion.

Examples of the anion include, but are not particularly limited to, a sulfate ion, a nitrate ion, a phosphate ion, a borate ion, an organic sulfonate ion, and a carboxylate ion. Examples of the dopant that generates sulfonate ions include benzenesulfonic acid, p-toluenesulfonic acid and naphthalenesulfonic acid.

Examples of the polyanion include a polymer anion. The solid electrolyte layer may contain, for example, a conjugated polymer including a monomer unit corresponding to a thiophene compound and a polymer anion.

Examples of the polymer anion include a polymer including a plurality of anionic groups. Examples of such a polymer include a polymer including a monomer unit including an anionic group. Examples of the anionic group include a sulfonic acid group and a carboxy group.

In the solid electrolyte layer, the anionic group of the dopant may be contained in a free form, an anion form, or a salt form, or may be contained in a form bonded or interacting with the conjugated polymer. All of these forms herein may be simply referred to as an “anionic group”, a “sulfonic acid group”, or a “carboxy group”, etc.

Examples of the polymer anion including a carboxy group include, but are not limited to, a copolymer using at least one of polyacrylic acid, polymethacrylic acid, acrylic acid, and methacrylic acid.

Specific examples of the polymer anion including a sulfonic acid group, for example, polymer type polysulfonic acids, include, but are not limited to, polyvinylsulfonic acid, polystyrenesulfonic acid (including copolymers and substituted products with substituents, etc.), polyallylsulfonic acid, polyacrylsulfonic acid, polymethacrylsulfonic acid, poly (2-acrylamide-2-methylpropanesulfonic acid), polyisoprenesulfonic acid, polyestersulfonic acid (aromatic polyester sulfonic acid, etc.), and phenolsulfonic acid novolac resin.

The amount of the dopant contained in the solid electrolyte layer ranges, for example, from 10 parts by mass to 1000 parts by mass, inclusive, and may range from 20 parts by mass to 500 parts by mass, inclusive, or from 50 parts by mass to 200 parts by mass, inclusive, with respect to 100 parts by mass of the conjugated polymer.

The solid electrolyte layer may further contain at least one kind selected from a group consisting of a known additive agent and a known conductive material other than the conductive polymer as necessary. Examples of conductive material include at least one kind selected from the group consisting of conductive inorganic materials such as manganese dioxide and TCNQ complex salts.

Between the dielectric layer and the solid electrolyte layer, a layer for improving adhesiveness may be interposed.

The solid electrolyte layer may be a single layer or may be formed of multiple layers. When the solid electrolyte layer is formed of the multiple layers, conductive polymers contained in the respective layers may be identical or different. Then, dopants included in the respective layers may be identical or different.

The solid electrolyte layer is formed by the electrolytic polymerization. The electrolytic polymerization can be performed by applying polymerization voltage while the anode foil including the dielectric layer is in contact with, for example, is immersed in the polymerization liquid (liquid composition) containing the precursor of the conductive polymer. The polymerization voltage is applied through the power feeder. The power feeder is connected (or attached) to the first insulating region. The power feeder is preferably connected (or attached) to the first insulating region while covering most of the first insulating region, particularly, the whole thereof in the width direction of the anode foil in a strip shape. This configuration suppresses formation of the solid electrolyte layer on the first insulating region to enhance the effect of securing insulation between the anode part and the cathode part.

The liquid composition contains the precursor of the conductive polymer. The precursor of the conductive polymer includes at least a precursor of the conjugated polymer, and includes the dopant as necessary. Examples of the precursor of the conjugated polymer include a raw material monomer of the conjugated polymer, and an oligomer and a prepolymer in which a plurality of molecular chains of the raw material monomer are linked. One kind of precursor may be used, or two or more kinds of precursor may be used in combination. From the viewpoint of easily obtaining higher orientation of the conjugated polymer, at least one kind (particularly, monomer) selected from a group consisting of a monomer and an oligomer is preferably used as the precursor.

The liquid composition typically contains a solvent. Examples of the solvent include at least one kind selected from a group consisting of water and an organic solvent.

When a dopant, another conductive material, an additive agent, and the like are used, they may be added to the liquid composition. Prior to the electrolytic polymerization, a precoat layer containing the conductive material may be formed on a surface of the dielectric layer.

The liquid composition may contain an oxidizing agent as necessary. Then, the oxidizing agent may be applied to the anode foil including the dielectric layer before or after the liquid composition is brought into contact with the anode foil. Examples of such an oxidizing agent include a compound capable of generating Fe³⁺ (such as a ferric sulfate), a persulfate (such as a sodium persulfate or an ammonium persulfate), and a hydrogen peroxide. The oxidizing agent may be used with one kind thereof or two or more kinds thereof in combination.

The electrolytic polymerization may be performed at a polymerization voltage in a range from 0.6 V to 1.5 V, or in a range from 0.7 V to 1 V, for example. The polymerization voltage is a potential of the power feeder y on a reference electrode (silver/silver chloride electrode (Ag/Ag⁺)).

The electrolytic polymerization may be performed at a temperature in a range from 5° C. to 60° C., or in a range from 15° C. to 35° C., for example.

### (Cathode Lead-Out Layer)

The cathode lead-out layer is required to include at least a first layer that is in contact with the solid electrolyte layer while covering at least a part of the solid electrolyte layer, and may include the first layer and a second layer covering the first layer. Examples of the first layer include a layer containing conductive particles, and metal foil. Examples of the conductive particles include at least one kind selected from conductive carbon and metal powder. For example, the cathode lead-out layer may be formed of a layer containing conductive carbon (also referred to as a carbon layer) as the first layer and a layer containing metal powder or metal foil as the second layer. When the metal foil is used as the first layer, the metal foil may constitute the cathode lead-out layer.

Examples of the conductive carbon include graphite such as artificial graphite or natural graphite.

The layer containing metal powder as the second layer can be formed by layering a composition containing metal powder on a surface of the first layer, for example. Examples of such a second layer include a metal paste layer formed using a composition containing metal powder such as silver particles, and a resin (binder resin). Although a thermoplastic resin is available for the resin, use of a thermosetting resin such as an imide resin or an epoxy resin is preferable.

When metal foil is used as the first layer, a kind of metal constituting the metal foil is not particularly limited. The metal foil is preferably formed using a valve metal such as aluminum, tantalum, or niobium, or an alloy containing the valve metal. The metal foil has a surface that may be roughened as necessary. The surface of the metal foil may be provided with an anodization film, and may be provided with a film of metal (dissimilar metal) different from the metal constituting the metal foil, or a nonmetal film. Examples of the dissimilar metal and the nonmetal include metal such as titanium, and nonmetal such as carbon (conductive carbon and the like).

The first layer may be formed of a film of the dissimilar metal or the nonmetal such as conductive carbon, and the second layer may be formed of the metal foil described above.

### (Separator)

When the metal foil is used for the cathode lead-out layer, a separator may be disposed between the metal foil and the anode foil. Available examples of the separator include, but are not particularly limited to, an unwoven fabric including fibers of cellulose, polyethylene terephthalate, vinylon, and polyamide (e.g., aliphatic polyamide or aromatic polyamide such as aramid).

### (Others)

The solid electrolytic capacitor may be a wound type, or may be either a chip type or a stacked type. The solid electrolytic capacitor is required to include at least one capacitor element, and may include multiple capacitor elements. For example, the solid electrolytic capacitor may include a stack body of two or more capacitor elements. When the solid electrolytic capacitor includes the multiple capacitor elements, each of the capacitor elements may be a wound type or a stacked type, for example. The capacitor element may have a configuration selected suitable for the type of the solid electrolytic capacitor.

The capacitor element includes the cathode lead-out layer to which one end part of a cathode lead terminal is electrically connected. The first part of the anode foil is electrically connected to one end part of an anode lead terminal. The anode lead terminal and the cathode lead terminal each have another end part that is drawn out from a resin exterior body or a case. The other end part of each lead terminal exposed from the resin exterior body or the case is used for solder connection or the like to a substrate on which the solid electrolytic capacitor is to be mounted. As each lead terminal, a lead wire may be used, or a lead frame may be used.

The capacitor element is sealed using the resin exterior body or the case. For example, the capacitor element and a material resin (e.g., uncured thermosetting resins and fillers) of the exterior body may be housed in a mold, and the capacitor element may be sealed with the resin exterior body by a transfer molding method, a compression molding method, or the like. At this time, a part close to the other end part of the anode lead terminal, and a part close the other end part of the cathode lead terminal, the parts being drawn out from the capacitor element, are each exposed from the mold. Then, the solid electrolytic capacitor may be formed by housing the capacitor element in a bottomed case while the part close to the other end part of the anode lead terminal and the part close the other end part of the cathode lead terminal are positioned close to an opening of the bottomed case, and sealing the opening of the bottomed case with a sealing body.

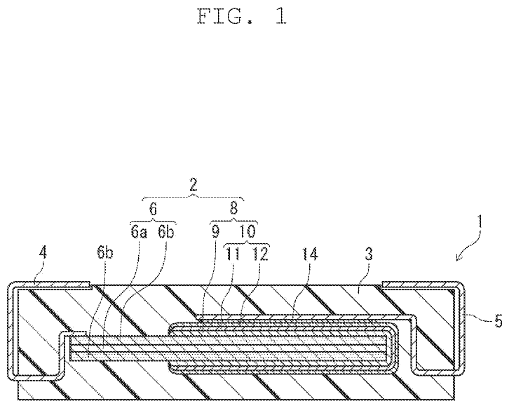

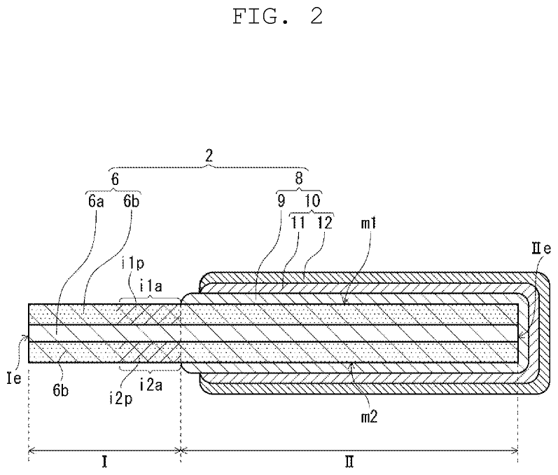

FIG. 1 is a schematic sectional view schematically illustrating a structure of a solid electrolytic capacitor according to a first exemplary embodiment of the present disclosure. FIG. 2 is an enlarged sectional view schematically illustrating capacitor element 2 included in the solid electrolytic capacitor of FIG. 1.

Solid electrolytic capacitor 1 includes capacitor element 2, exterior body 3 that seals capacitor element 2, and anode lead terminal 4 and cathode lead terminal 5 that are each at least partially exposed to the outside of exterior body 3. Exterior body 3 has a substantially rectangular parallelepiped outer shape, and solid electrolytic capacitor 1 also has a substantially rectangular parallelepiped outer shape.

Capacitor element 2 includes anode foil 6, a dielectric layer (not shown) covering a surface of anode foil 6, and cathode part 8 covering the dielectric layer. The dielectric layer may be formed on at least a part of the surface of anode foil 6.

Cathode part 8 includes solid electrolyte layer 9 and cathode lead-out layer 10. Solid electrolyte layer 9 is formed by electrolytic polymerization while covering at least a part of the dielectric layer. Cathode lead-out layer 10 is formed covering at least a part of solid electrolyte layer 9. Cathode lead-out layer 10 includes, for example, first layer 11 that is a carbon layer and second layer 12 that is a metal paste layer. Cathode lead terminal 5 is electrically connected to cathode part 8 with adhesive layer 14 made of a conductive adhesive and interposed therebetween.

Anode foil 6 includes base material part 6a and porous part 6b formed on a surface of base material part 6a. Porous part 6b is formed in a surface layer of anode foil 6. Anode foil 6 includes first part I where solid electrolyte layer 9 (or cathode part 8) is not formed, and second part II other than first part I. First part I is electrically connected to anode lead terminal 4 by welding. Anode foil 6 has first end Ie connected to anode lead terminal 4 and second end IIe opposite to first end Ie.

Anode foil 6 has first principal surface m1 and second principal surface m2 opposite to first principal surface m1. Between first end Ie and second end IIe, anode foil 6 is provided with first insulating part i1p located at a side close to first principal surface m1, and second insulating part i2p located at a side close to second principal surface m2. First insulating part i1p includes porous part 6b containing the first insulating material, and an outer surface of first insulating part i1p constituting first insulating region i1a. Second insulating part i2p includes porous part 6b containing at least a liquid-repellent material, and an outer surface of second insulating part i2p constituting second insulating region i2a.

Exterior body 3 is configured to cover a part of capacitor element 2 and lead terminals 4, 5. From the viewpoint of suppressing ingress of air to the inside of exterior body 3, capacitor element 2 and lead terminals 4, 5 are partially sealed with exterior body 3. Although FIG. 1 illustrates a resin exterior body serving as exterior body 3, the present disclosure is not limited thereto, and exterior body 3 may be a case or the like capable of housing capacitor element 2. The resin exterior body is formed by partially sealing capacitor element 2 and lead terminals 4, 5 with a resin material.

Anode lead terminal 4 and cathode lead terminal 5 each have one end part electrically connected to capacitor element 2, and another end part drawn out of exterior body 3. Solid electrolytic capacitor 1 includes exterior body 3 covering the one end part of each of lead terminals 4, 5 together with capacitor element 2.

### Examples

Hereinafter, the present invention is specifically described with reference to examples and comparative examples, but the present invention is not limited to the following examples.

<<Solid electrolytic capacitor A1>>

Solid electrolytic capacitor 1 (solid electrolytic capacitor A1) illustrated in FIG. 1 was produced in the following manner, and its characteristics were evaluated.

### (1) Preparation of Anode Foil 6

Both surfaces of aluminum foil (thickness: 100 μm) as a base material were roughened by etching to prepare anode foil 6 including porous part 6b in a surface layer.

### (2) Formation of Dielectric Layer

Second part II of anode foil 6 was immersed in an anodizing solution, and a DC voltage of 70 V was applied for 20 minutes to form a dielectric layer containing aluminum oxide.

### (3) Formation of First Insulating Region i1a and Second Insulating Region i2a

First insulating part i1p was formed by impregnating a predetermined region of porous part 6b on first principal surface m1 of anode foil 6, on which the dielectric layer was formed, with a polyamideimide resin as a first insulating material. The impregnated region is formed in a band shape along the whole of anode foil 6 in its width direction. And then heating the polyamideimide resin at 200° C. for 30 minutes is performed. An outer surface of first insulating part i1p constitutes first insulating region i1a. Width w1 of first insulating region i1a is 0.07 L with respect to length L of anode foil 6.

Subsequently, second insulating part i2p was formed by impregnating a predetermined region of porous part 6b on second principal surface m2 of anode foil 6 with a mixture of a polyamideimide resin and a fluororesin (“MEGAFACE RS-76 E” manufactured by DIC Corporation) as a liquid-repellent material. The impregnated region is formed in a band shape along the whole of anode foil 6 in its width direction. And then heating the mixture at 200° C. for 30 minutes is performed. An outer surface of second insulating part i2p constitutes second insulating region i2a. Width w2 of second insulating region i2a is 0.07 L with respect to length L of anode foil 6.

### (4) Formation of Solid Electrolyte Layer 9

Second part II of anode foil 6 obtained in step (3) above was immersed in a liquid composition containing a conductive material, and was taken out and dried to form a precoat layer (not illustrated). A power feeding tape was attached to the outer surface of the first insulating region i1a.

A polymerization liquid (liquid composition) containing pyrrole (monomer of conjugated polymer), naphthalenesulfonic acid (dopant), and water was prepared. Anode foil 6 on which the precoat layer was formed and a counter electrode were immersed in the polymerization liquid obtained. The power feeding tape was subjected to voltage to have a potential of 1.0 V (=polymerization voltage), and electrolytic polymerization was performed at 25° C. to form solid electrolyte layer 9. The polymerization voltage is a potential of the power feeder with respect to the reference electrode (silver/silver chloride reference electrode).

### (5) Formation of Cathode Lead-Out Layer 10

Anode foil 6 on which solid electrolyte layer 9 obtained in step (4) above was formed was immersed in a dispersion liquid in which graphite particles were dispersed in water, and was taken out from the dispersion liquid and then dried to form first layer 11 being a carbon layer at least on a surface of solid electrolyte layer 9. The drying was performed at 150° C. for 30 minutes.

Next, a silver paste containing silver particles and a binder resin (epoxy resin) was applied onto a surface of first layer 11, and heated at 150° C. for 30 minutes to cure the binder resin, thereby forming second layer 12 being a metal paste layer. Cathode lead-out layer 10 composed of first layer 11 and second layer 12 was thus formed to form cathode part 8 composed of solid electrolyte layer 9 and cathode lead-out layer 10.

Capacitor element 2 was produced as described above.

### (6) Assembly of Solid Electrolytic Capacitor

Cathode part 8 of capacitor element 2 obtained in step (5) above was bonded to one end part of cathode lead terminal 5 with adhesive layer 14 of a conductive adhesive. One end part of anode lead terminal 4 was bonded to first end Ie of anode foil 6 by laser welding, first end Ie protruding from capacitor element 2.

Subsequently, resin exterior body 3 formed of an insulating resin is formed around capacitor element 2 by molding. At this time, the other end part of anode lead terminal 4 and the other end part of cathode lead terminal 5 were drawn out from resin exterior body 3.

In this way, solid electrolytic capacitor 1 (A1) was completed. In the same manner as described above, twenty solid electrolytic capacitors were produced in total.

### <<Solid Electrolytic Capacitor B1>>

When the second insulating part i2p was formed in step (3) above, the same material as the first insulating material was used as the second insulating material instead of the liquid-repellent material and was heated at 200° C. for 30 minutes. Except the above, twenty solid electrolytic capacitors B1 were produced in total in the same manner of solid electrolytic capacitors A1.

### [Evaluation]

The following evaluations were performed using the solid electrolytic capacitors or evaluation samples.

### (a) Water Repellency of First Insulating Region and Second Insulating Region

According to the procedure described above, a static contact angle (°) of water on the material contained in each of the first insulating region and the second insulating region was obtained and used as an index of water repellency R1 or R2 of the corresponding one of the insulating regions.

### (b) Initial Electrostatic Capacity and Equivalent Series Resistance (ESR)

Under an environment of 20° C., initial electrostatic capacity (μF) of each solid electrolytic capacitor at a frequency of 120 Hz was measured, and initial ESR (mΩ) at a frequency of 100 kHz was measured using an LCR meter for 4-terminal measurement. Then, an average value of measured values for twenty electrolytic capacitor was obtained.

### (c) Leakage Current

Each of the solid electrolytic capacitors was connected to a resistor of 1 kΩ in series, and a leakage current (μA) was measured after a rated voltage of 25 V was applied to each of the solid electrolytic capacitors for 1 minute by a DC power source. Then, an average value of measured values for twenty electrolytic capacitors was obtained.

Evaluation results are shown in Table 1.

TABLE 1

| | | | Initial electrostatic | Initial ESR | Leakage current |
|---|---|---|---|---|---|
| | R1 | R2 | capacity (μF) | (mΩ) | (μA) |
| A1 | 71° | ≥80° | 69.3 | 5.5 | 0.5 ± 0.5 |
| B1 | 71° | 71° | 69.0 | 5.6 | 3.5 ± 6.5 |

As shown in Table 1, the examples have a smaller leakage current and standard deviation than the comparative examples. It is considered that the leakage current was increased in the solid electrolytic capacitor of the comparative example due to solid electrolyte layer 9 that was also formed on the surface of second insulating region i2a.

### INDUSTRIAL APPLICABILITY

The solid electrolytic capacitor of the present disclosure enables reducing a leakage current and acquiring excellent capacitor performance. Thus, the solid electrolytic capacitor can be used for various applications requiring high reliability, for example.

### REFERENCE MARKS IN THE DRAWINGS

1 solid electrolytic capacitor
2 capacitor element
3 exterior body
4 anode lead terminal
5 cathode lead terminal
6 anode foil
6a base material part
6b porous part
8 cathode part
9 solid electrolyte layer
10 cathode lead-out layer
11 first layer
12 second layer
14 adhesive layer
I first part
II second part
Ie first end
IIe second end
m1 first principal surface
m2 second principal surface
i1p first insulating part
i2p second insulating part
i1a first insulating region
i2a second insulating region

1. A solid electrolytic capacitor comprising a capacitor element, the capacitor element including:
an anode foil including a porous part in a surface layer of the anode foil,
a dielectric layer covering at least a part of the porous part, and
a solid electrolyte layer covering at least a part of the dielectric layer, wherein:
the anode foil includes a first part and a second part, the first part including a first end of the anode foil and being not provided with the solid electrolyte layer, the second part including a second end of the anode foil opposite to the first end and excluding the first part, the anode foil having a first principal surface and a second principal surface opposite to the first principal surface,
the capacitor element further includes a first insulating region and a second insulating region between the first end and the second end, the first insulating region being located at side close to the first principal surface, the second insulating region being located at side close to the second principal surface, and
water repellency R2 of at least a part of the second insulating region is higher than water repellency R1 of the first insulating region.

2. The solid electrolytic capacitor according to claim 1, wherein each of the first insulating region and the second insulating region is provided in a band shape along a width direction of the anode foil, the width direction of the anode foil being a direction perpendicular to a length direction of the anode foil that is a direction extending from the first end to the second end.

3. The solid electrolytic capacitor according to claim 2, wherein the each of the first insulating region and the second insulating region is provided over an entirety of the anode foil in the width direction.

4. The solid electrolytic capacitor according to claim 2, wherein a width w2 of the second insulating region is in a range from 0.01 L to 0.3 L, inclusive, where L represents a length of the anode foil.

5. The solid electrolytic capacitor according to claim 1, wherein:
the water repellency R2 is represented by a static contact angle of water on a material contained in the second insulating region, and
the static contact angle ranges from 75 degrees to 180 degrees, inclusive.

6. The solid electrolytic capacitor according to claim 1, wherein:
the capacitor element further includes a first insulating part and a second insulating part, the first insulating part including a first insulating material and being disposed in the porous part at a side close to the first principal surface, the second insulating part including an insulating liquid-repellent material and being disposed in the porous part at a side close to the second principal surface,
an outer surface of the first insulating part constitutes the first insulating region, and
an outer surface of the second insulating part constitutes the second insulating region.

7. The solid electrolytic capacitor according to claim 1, wherein:
the capacitor element further includes a first insulating part and a second insulating part, the first insulating part including a first insulating material and being disposed in the porous part at a side close to the first principal surface, the second insulating part including an insulating liquid-repellent material and being disposed in the porous part at a side close to the second principal surface,
the second insulating part further includes a second insulating material in the porous part at a side close to the second principal surface, at least a part of the second insulating material being covered with the liquid-repellent material,
an outer surface of the first insulating part constitutes the first insulating region, and
an outer surface of the second insulating part constitutes the second insulating region.

8. The solid electrolytic capacitor according to claim 1, wherein:
the solid electrolyte layer includes a conjugated polymer, and
the conjugated polymer includes a monomer unit corresponding to at least one selected from the group consisting of a pyrrole compound, a thiophene compound, and an aniline compound.

9. A method for manufacturing a solid electrolytic capacitor including a capacitor element, the capacitor element including an anode foil including a porous part on a surface layer, a dielectric layer covering at least a part of the porous part, and a solid electrolyte layer covering at least a part of the dielectric layer,
the anode foil including a first part and a second part, the first part including a first end of the anode foil and being not provided with the solid electrolyte layer, the second part including a second end of the anode foil opposite to the first end and excluding the first part, the anode foil having a first principal surface and a second principal surface opposite to the first principal surface,
the method comprising a step of forming a first insulating region and a second insulating region between the first end and the second end, the first insulating region being located at a side close to the first principal surface, the second insulating region being located at a side close to the second principal surface, wherein
water repellency R2 of at least a part of the second insulating region is higher than water repellency R1 of the first insulating region.
